(19) United States
(12) Patent Application Publication
(10) Pub. No.: US 2013/0334019 A1
(43) Pub. Date: Dec. 19, 2013

(54) Key Structure of a Keyboard

(71) Applicant: Tianliang Lan, Shenzhen (CN)

(72) Inventor: Tianliang Lan, Shenzhen (CN)

(21) Appl. No.: 13/258,831

(22) PCT Filed: Feb. 28, 2011
(86) PCT No.: PCT/CN11/71409

§ 371 Date: Sep. 22, 2011

(30) Foreign Application Priority Data
Nov. 17, 2010 (CN) 201020611192.7
Nov. 17, 2010 (CN) 201020611343.9

(51) Int. Cl. H01H 3/12

(52) U.S. Cl. CPC H01H 3/125
USPC 200/344

(57) ABSTRACT

A key structure of a keyboard of the present invention includes a base board and a scissors structure mounted on the base board. The base board is provided with a groove, and a pair of clasps extends upwards from opposite two sides of the groove. The scissors structure includes a first frame and a second frame rotationally connected with the first frame. One end of the first frame is provided with a first rotation spindle, and the first rotation spindle is rotationally connected with the clasps and abuts against the edge of the groove opposite to the clasps. In the present invention, the first rotation spindle abuts against the edge of the groove, which is good for the first rotation spindle being mounted in position to the clasps while assembling the scissors structure, can avoid side slip, and makes the inner structure of the key more stable.

### FIELD OF THE INVENTION

The present invention relates to a key structure of a keyboard, particularly to s a key structure of a keyboard which facilitates to mount a scissors structure and improve stability.

### BACKGROUND OF THE INVENTION

A keyboard as a general input device is widely used in computers and other various electrical devices. Various kinds of conventional key structures are used in computer keyboards. A scissors structure is one kind of typical structure.

Since a structure of a keyboard is developing towards miniaturization, an area of a keycap of a key is reduced accordingly, which makes the internal structure of the key complicated. Thus, the stability of the internal structure of a key can not be ensured, the scissors structure is not easy to be assembled, and side slip easily occurs while the key is pressed. So, it is necessary to further improve the conventional key structure of a keyboard.

### SUMMARY OF THE INVENTION

An object of the present invention is to provide a key structure of a keyboard, by improving the scissors structure, which facilitates to assemble a scissors structure and makes the internal structure of the key more stable.

To achieve the above mentioned object, a key structure of a keyboard of the present invention comprises a base board and a scissors structure mounted on the base board. The base board is provided with a groove, and a pair of clasps extends upwards from opposite two sides of the groove. The scissors structure includes a first frame and a second frame rotationally connected with the first frame. One end of the first frame is provided with a first rotation spindle, and the first rotation spindle is rotationally connected with the clasps and abuts against the edge of the groove opposite to the clasps.

The first rotation spindle is provided with first and second surfaces opposite to each other, and inner and outer sides opposite to each other; the junction of the outer side and the first surface is provided with a chamfer.

The chamfer is a rounding.

The pair of clasps are respectively provided at the lateral margins at the opposite two sides of the groove.

The key structure of a keyboard further comprises a thin film circuit board fixed on the base board, an elastic body fixed above the thin film circuit board, and a keycap. The centre of the scissors structure is provided with a hollow part; the elastic body is located above the thin film circuit board and in the hollow part at the centre of the scissors structure; the keycap is located on the elastic body; the thin film circuit board is provided with a first through hole corresponding to the groove and the clasps of the base board.

The inner side of the keycap is provided with a pair of gourd clasps and a pair of sliding grooves, and, the base board is also provided with a pair of slide clasps extending upwards therefrom.

The other end of the first frame is provided with a first slide spindle that is moveably connected with the sliding grooves inside the keycap.

One end of the second frame is provided with a second rotation spindle, and the other end is provided with a second slide spindle. The second slide spindle is moveably connected with the slide clasps of the base board, and the second rotation spindle is connected with the gourd clasps inside the keycap.

The key structure of a keyboard further comprises a layer of polyester film located between the thin film circuit board and the elastic body, and the polyester film is provided with a second through hole corresponding to the groove and the clasps of the base board.

The advantages of the present invention are that: the first rotation spindle abuts against the edge of the groove, which facilitates the first rotation spindle to be mounted in position to the clasps while assembling the scissors structure, can avoid side slip, and makes the internal structure of the key more stable. Moreover, the first rotation spindle is provided with a chamfer to guide and slide the scissors structure to be assembled in position, which facilitate to assemble, and the structure of the chamfer can effectively reduce attritions and cracks generated in using, so as to extend the service life of the key.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

The technical solution and the beneficial effects of the present invention are best understood from the following detailed description with reference to the accompanying figures and embodiments.

In the figures:

FIG. 1 is an exploded view of a key structure of a keyboard in accordance with a first embodiment of the present invention;

FIG. 2 is a top plan view of FIG. 1;

FIG. 3 is a view of part of the present invention, in which a scissors structure has been assembled to a base board;

FIG. 4 is a view illustrating working status of the structure in FIG. 3;

FIG. 5 is a sectional view of FIG. 3 along A-A direction;

FIG. 6 is a sectional view of FIG. 4 along B-B direction;

FIGS. 7-8 are sectional views of a key structure of a keyboard in accordance with a second embodiment of the present invention, in which the first frame is assembling to the base board.

### DESCRIPTION OF THE PREFERRED EMBODIMENT

To further set forth the technical solution adopted by the present invention and the effects thereof, the present invention is described detailedly with reference to the following preferred embodiments and the accompanying figures.

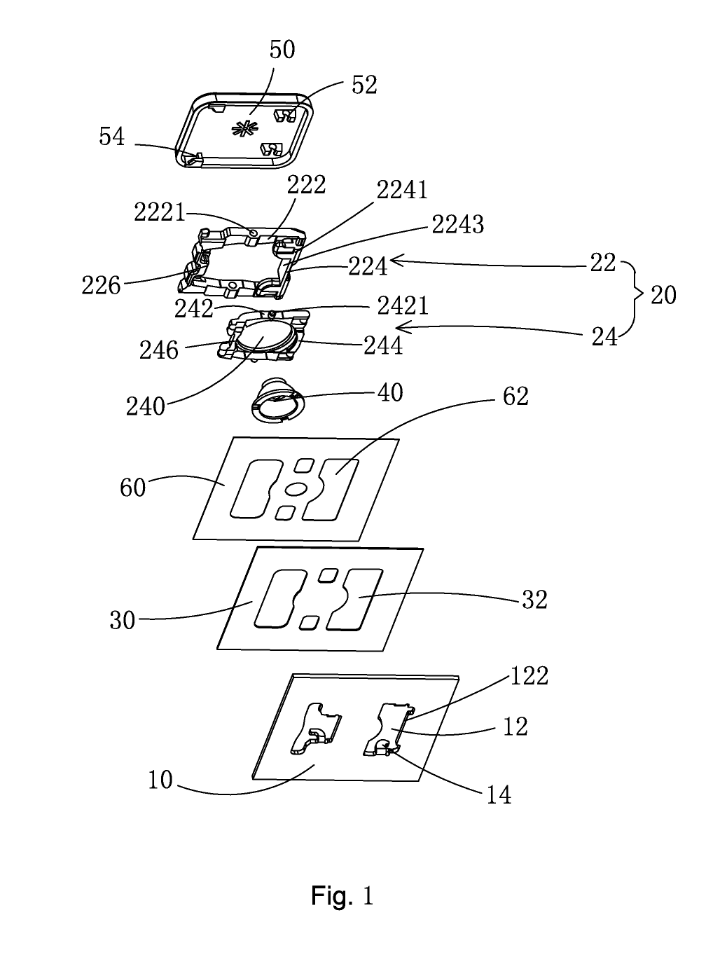

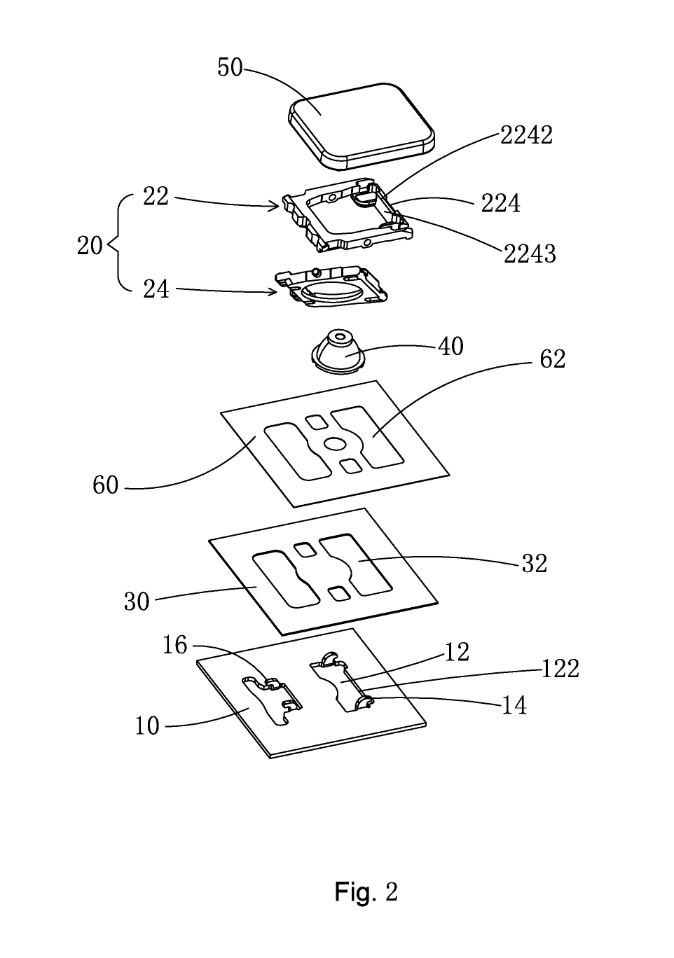

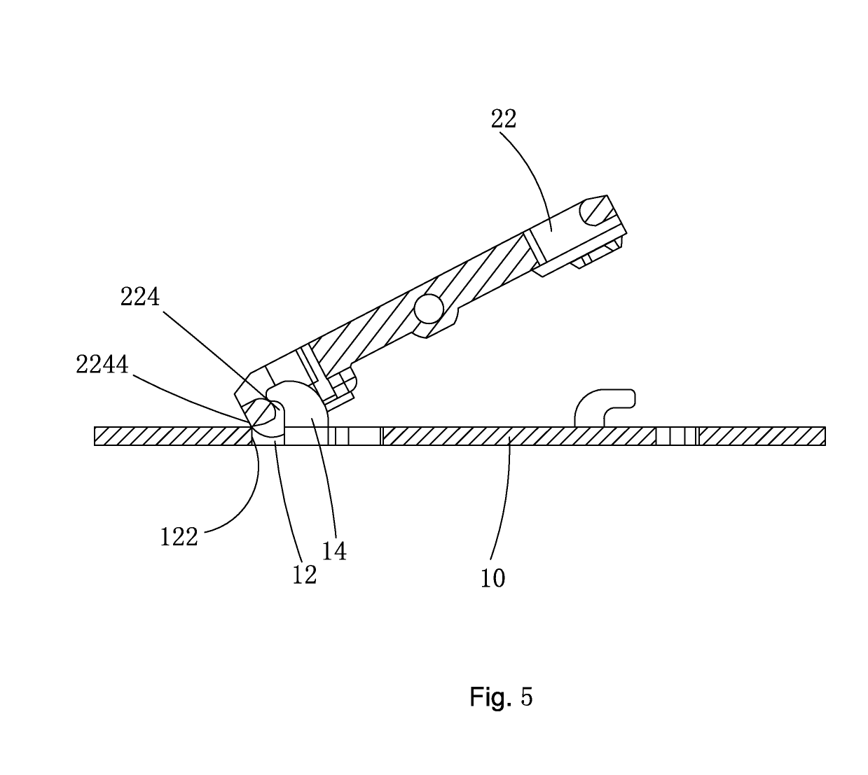

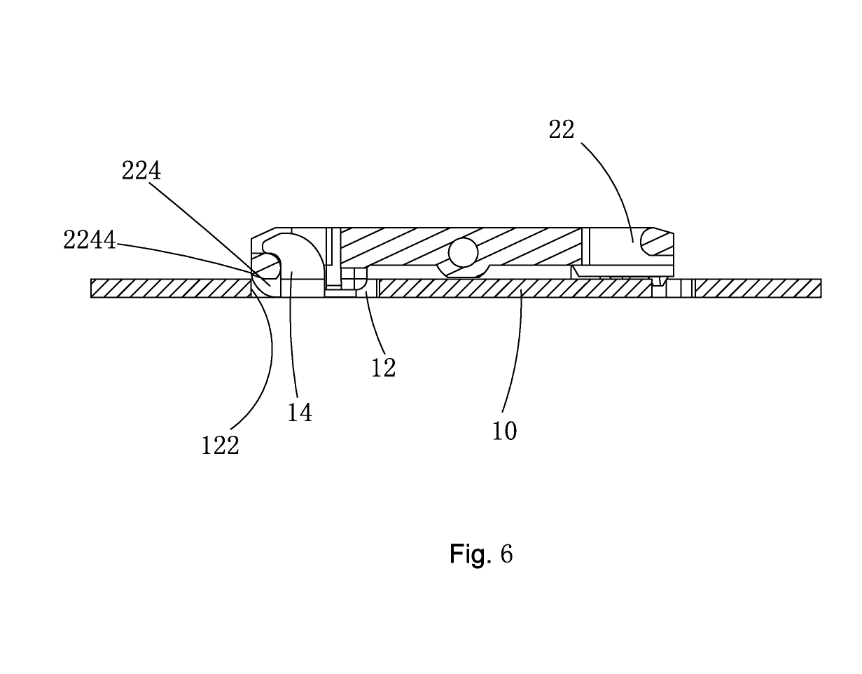

As shown in FIGS. 1-6, a key structure of a keyboard in accordance with a first embodiment of the present invention comprises a base board 10, a scissors structure 20 mounted on the base board 10, a thin film circuit board 30 fixed on the base board 10, an elastic body 40 mounted on the thin film circuit board 30, and a keycap 50. The centre of the scissors structure 20 is provided with a hollow part 240. The elastic body 40 is located above the thin film circuit board 30 and in the hollow part 240 at the centre of the scissors structure 20. The keycap 50 is located on the elastic body 40. The base board 10 is provided with a groove 12, and a pair of clasps 14 are extending upwards from opposite two sides of the groove 12. In the present embodiment, the pair of clasps 14 are provided at the lateral margins at the opposite two sides of the groove 12. The thin film circuit board 30 is provided with a first through hole 32 corresponding to the groove 12 and the clasps 14 of the base board 10. The base board 10 is also provided with a pair of slide clasps 16 extending upwards therefrom.

Alternatively, the present embodiment also comprises a layer of polyester film 60 located between the thin film circuit board 30 and the elastic body 40, and the polyester film 60 is provided with a second through hole 62 corresponding to the groove 12 and the clasps 14 of the base board 10.

Specifically, the scissors structure 20 comprises a first frame 22, and a second frame 24 rotationally connected with the first frame 22. The first frame 22 comprises two symmetrical first side bars 222, a first rotation spindle 224 connected with one end of the two first side bars 222, and a first slide spindle 226 connected with the other end of the two first side bars 222. The first rotation spindle 224 comprises first and second surfaces 2241, 2242 opposite to each other, and inner and outer sides 2243, 2244 opposite to each other. The second frame 24 comprises two symmetrical second side bars 242, a second rotation spindle 244 connected with one end of the two second side bars 242, and a second slide spindle 246 connected with the other end of the two second side bars 242. The middle of the first side bar 222 is provided with a middle hole 2221, and the middle of the second side bar 242 is provided with a middle spindle 2421. By combining the middle holes 2221 with the middle spindles 2421, the first frame 22 and the second frame 24, which are mutually crossed to be connected rotationally, form a scissors type structure. The hollow part 240 is located at the central position of the second frame 24. The first rotation spindle 224 is rotationally connected with the clasps 14 and abuts against the edge 122 of the groove 12 opposite to the clasps 14, thereby facilitating to mount and position the first rotation spindle 224 and the clasps 14 as assembling the scissors structure. The inner side of the keycap 50 is provided with a pair of gourd clasps 52 and a pair of sliding grooves 54. The first slide spindle 226 is moveably connected with the sliding grooves 54 inside the keycap 50. The second slide spindle 246 is moveably connected with the slide clasps 16 of the base board 10. The second rotation spindle 244 is connected with the gourd clasps 52 inside the keycap 50.

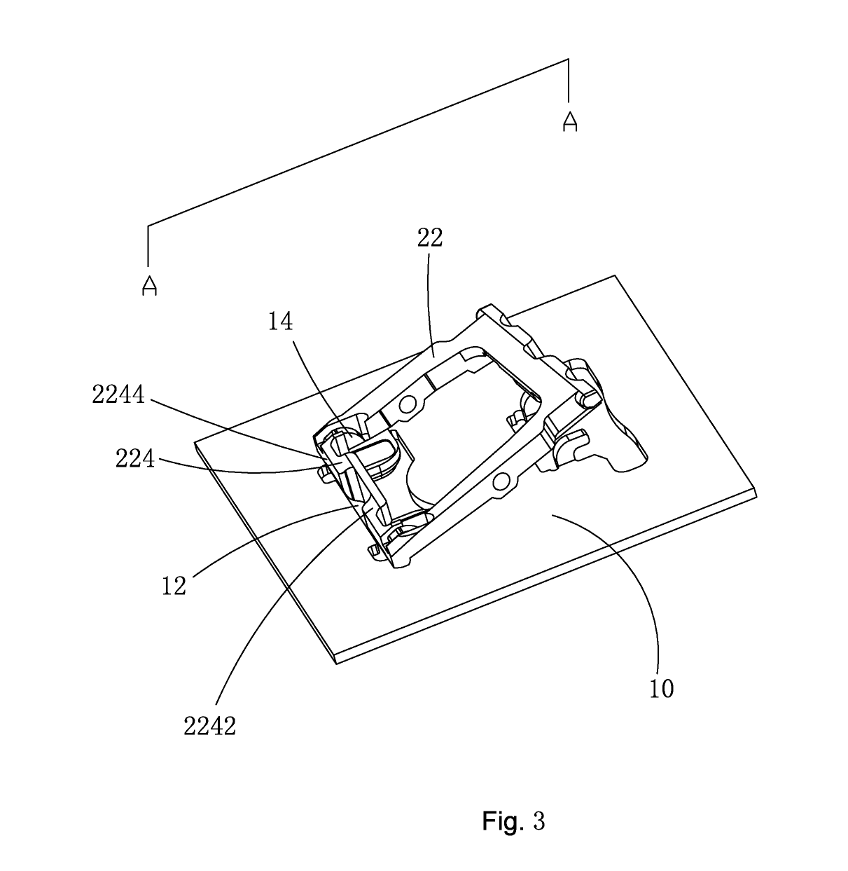

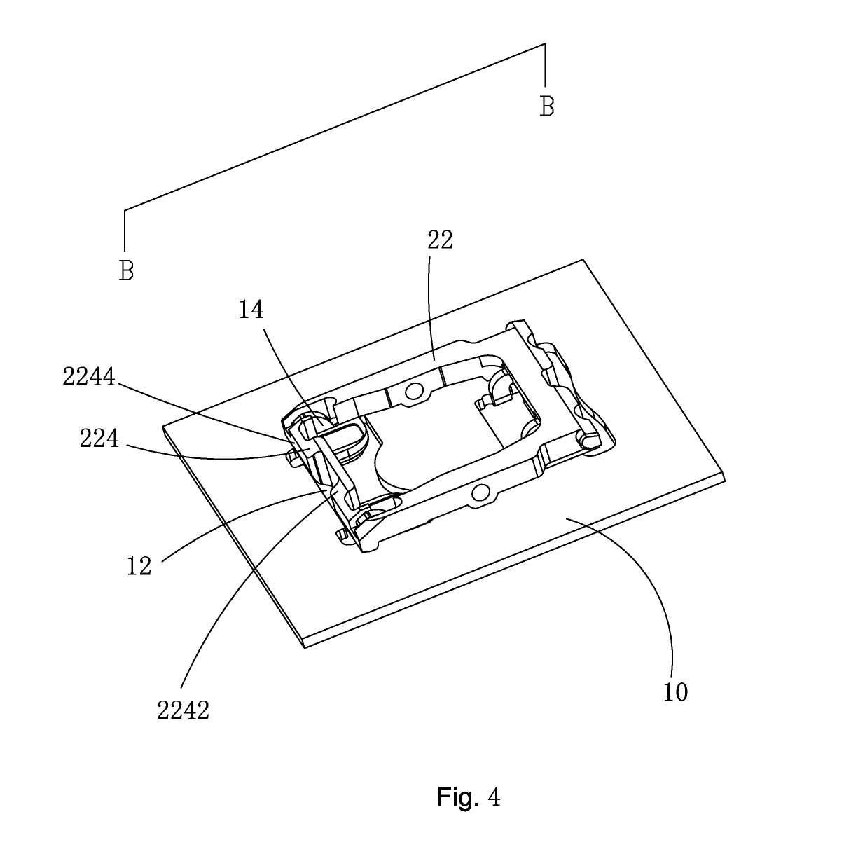

In assembly, the base board 10 is first put on a worktable, then the thin film circuit board 30 is fixed to the base board 10, then the polyester film 60 is mounted to the thin film circuit board 30, then the second slide spindle 246 of the second frame 24 is connected with the slide clasps 16 of the base board 10, then the first rotation spindle 224 of the first frame 22 in turn extends through the second through hole 62 of the polyester film 60 and the first through hole 32 of the thin film circuit board 30 to abut against the position where the groove 12 of the base board 10 and the surface of the base board 10 are connected, then the first rotation spindle 224 is moved along the position where the groove 12 and the surface of the base board 10 are connected towards the direction of the groove 12, and, finally the first rotation spindle 224 is moved to the edge 122 of the groove 12 and the first rotation spindle 224 is rotationally connected with the clasps 14, thereby finishing assembling the scissors structure 20 on the base board 10. As shown in FIGS. 3-6, if the second frame 24, the polyester film 60 and the thin film circuit board 30 are removed, it can be seen that the first rotation spindle 224 is located in the groove 12 and abuts against the edge 122 of the groove 12, so as to make the first rotation spindle 224 be mounted in position and be closely combined with the clasps 14. Furthermore, the outer side 2244 of the first rotation spindle 224 abuts against the edge 122 of the groove 12, and the outer side 2244 has the function of mounting and positioning, so as make the internal structure of the key more stable. While working, as shown in FIGS. 4-6, the keycap 50 is pressed, then the first rotation spindle 224 rotates relative to the clasps 14, and, the first rotation spindle 224 is located in the groove 12 and abuts against the edge 122 of the groove 12 to be closely combined with it, thereby effectively avoiding side slip.

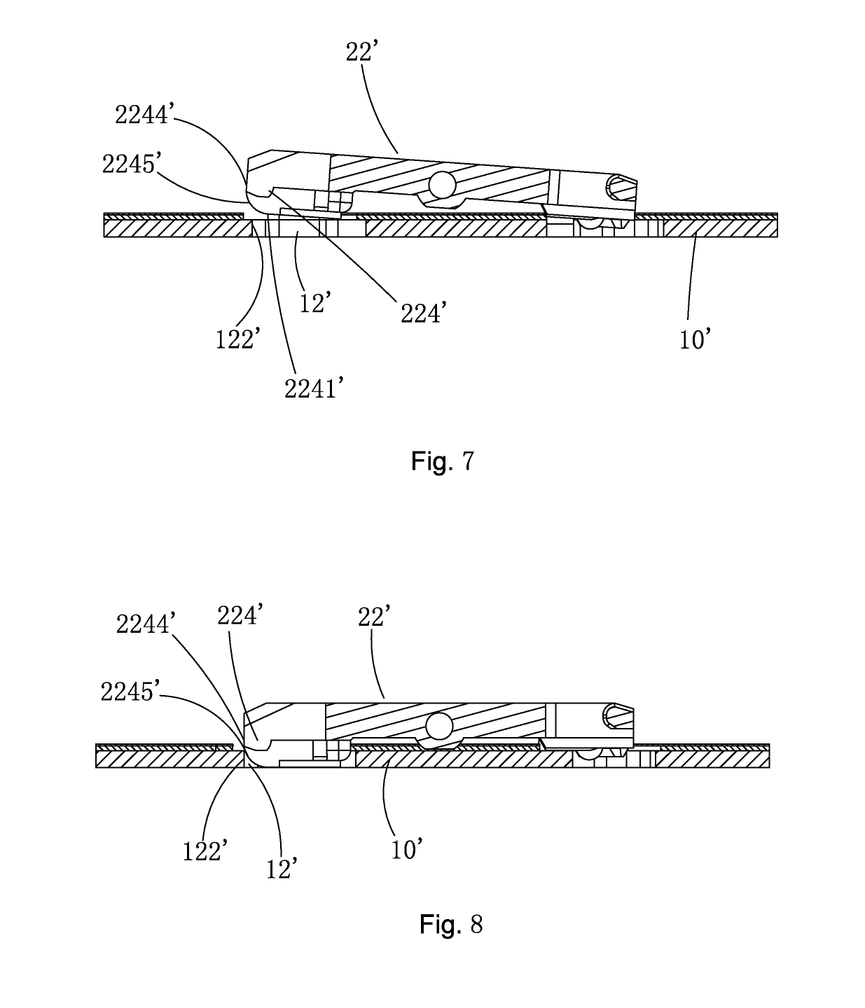

More preferably, a second embodiment of the present invention is illustrated in FIGS. 7-8. Comparing to the first embodiment, the junction of the outer side 2244′ of the first rotation spindle 224′ and the first surface 2241′ is provided with a chamfer 2245′, and the chamfer 2245′ is a rounding. While assembling, as the first rotation spindle 224′ is moved along the junction of the groove 12′ and the surface of the base board 10′ towards the direction of the groove 12′, via guiding and sliding of the chamfer 2245′, the first rotation spindle 224′ slides to the edge 122′ of the groove 12′ and is rotationally connected with the clasps, so as to finish assembling the first frame 22′ to the base board 10′. The arrangement of the chamfer 2245′ is good for mounting the first rotation spindle 224′ in position, and can effectively reduce attritions and cracks generated in using the key, so as to extend the service life of the key. After assembly, the outer side 2244′ of the first rotation spindle 224′ is pressed into the groove 12′ from the edge 122′ of the groove' of the base board 10′ to be positioned, and, the chamfer 2245′ and the outer side 2244′ have the function of mounting and positioning. The other structures of the second embodiment are the same as those of the first embodiment.

In summary, in the present invention, the first rotation spindle abuts against the edge of the groove, which is good for the first rotation spindle being mounted in position to the clasps while assembling the scissors structure, can avoid side slip, and makes the inner structure of the key more stable. Moreover, the first rotation spindle is provided with a chamfer to guide and slide the scissors structure to be assembled in position, which is good for assembling, and the structure of the chamfer can effectively reduce attritions and cracks generated in using, so as to extend the service life of the key.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A key structure of a keyboard comprising a base board and a scissors structure mounted on the base board; the base board being provided with a groove, and a pair of clasps extending upwards from opposite two sides of the groove; the scissors structure including a first frame and a second frame rotationally connected with the first frame; one end of the first frame being provided with a first rotation spindle, and the first rotation spindle being rotationally connected with the clasps and abutting against the edge of the groove opposite to the clasps.

2. The key structure of a keyboard of claim 1, wherein the first rotation spindle is provided with first and second surfaces opposite to each other, and inner and outer sides opposite to each other; a junction of the outer side and the first surface is provided with a chamfer.

3. The key structure of a keyboard of claim 2, wherein the chamfer is a rounding.

4. The key structure of a keyboard of claim 1, wherein the pair of clasps are respectively provided at lateral margins at opposite two sides of the groove.

5. The key structure of a keyboard of claim 1, further comprising a thin film circuit board fixed on the base board, an elastic body mounted on the thin film circuit board, and a keycap; the centre of the scissors structure is provided with a hollow part; the elastic body is located above the thin film circuit board and in the hollow part at the centre of the scissors structure; the keycap is located on the elastic body; the thin film circuit board is provided with a first through hole corresponding to the groove and the clasps of the base board.

6. The key structure of a keyboard of claim 5, wherein the inner side of the keycap is provided with a pair of gourd clasps and a pair of sliding grooves, and, the base board is further provided with a pair of slide clasps extending upwards therefrom.

7. The key structure of a keyboard of claim 6, wherein the other end of the first frame is provided with a first slide spindle that is moveably connected with the sliding grooves inside the keycap.

8. The key structure of a keyboard of claim 6, wherein one end of the second frame is provided with a second rotation spindle, and the other end is provided with a second slide spindle; the second slide spindle is moveably connected with the slide clasps of the base board, and the second rotation spindle is connected with the gourd clasps inside the keycap.

9. The key structure of a keyboard of claim 5, further comprising a layer of polyester film located between the thin film circuit board and the elastic body, and the polyester film is provided with a second through hole corresponding to the groove and the clasps of the base board.
